(19) United States
(12) Patent Application Publication
(10) Pub. No.: US 2007/0293114 A1
(43) Pub. Date: Dec. 20, 2007

(54) FIRE RESISTANT BARRIER HAVING CHEMICAL BARRIER LAYER

(75) Inventor: Steven E. OGLE, Cary, NC (US)

Correspondence Address: CONLEY ROSE, P.C., 5601 GRANITE PARKWAY, SUITE 750, PLANO, TX, 75024, US

(73) Assignee: L&P Property Management Company, South Gate, CA (US)

(21) Appl. No.: 11/762,662

(22) Filed: Jun. 13, 2007

Related U.S. Application Data
(60) Provisional application No. 60/813,378, filed on Jun. 14, 2006.
(60) Provisional application No. 60/813,541, filed on Jun. 14, 2006.

(51) Int. Cl. B32B 27/12; D04H 1/00; D04H 13/00

(52) U.S. Cl. 442/414; 442/415; 442/416; 442/136

(57) ABSTRACT

Disclosed is an FR barrier that may be used to enhance the fire resistance characteristics of a product, and an associated method for forming such an FR barrier. The FR barrier includes a chemical barrier layer and an FR nonwoven fiber batt. The chemical barrier layer improves the FR characteristics of the FR nonwoven fiber batt, often by depriving flame of oxygen, while the FR nonwoven fiber batt may shield a combustible layer of a product from direct contact with flame. The chemical barrier layer is often applied to the distal side surface of the FR nonwoven fiber batt.

### CROSS-REFERENCE TO RELATED APPLICATIONS

This application is related to and claims priority to U.S. Provisional Patent Application Ser. No. 60/813,378 (Atty. Docket No. 4003-08201) entitled “Method of Manufacturing A Durable Fire Resistant Nonwoven Fiber Batt Using Non-Inherently Fire Resistant Fibers,” and to U.S. Provisional Patent Application Ser. No. 60/813,541 (Atty. Docket No. 4003-21501) entitled “Heat Absorptive Bi-Layer Fire Resistant Nonwoven Fiber Batt,” both of which have been assigned to the Assignee of the present application and are hereby incorporated by reference as if reproduced in the entirety.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE DISCLOSURE

The present disclosure relates to fire resistant (FR) nonwoven fiber batts and, more particularly, to an FR barrier formed from an FR nonwoven fiber batt and a chemical barrier layer.

### BACKGROUND

FR products are desirable in a wide variety of applications. Products for both private occupancy such as homes and public occupancy such as health care facilities, convalescent care homes, college dormitories, residence halls, hotels, motels and correctional institutions are often governed by regulations which require the products meet certain FR standards. This is particularly true when bedding and upholstered products are concerned. For example, California Technical Bulletins (TBs) 116 and 603 set FR standards for upholstered furniture and mattress/box spring sets, respectively. Components having certain FR characteristics are also needed in a wide array of other applications where fire safety is a concern, including, but not limited to apparel, fire safety gear, vehicle seating and insulators used in a wide variety of applications.

FR is a relative term which is typically based upon a determination as to whether a specific product satisfies a particular FR standard. For example, a mattress may satisfy the requirements of 16 CFR §1632 (the Federal Standard for the resistance of a mattress or mattress pad to combustion which may result from a smoldering cigarette) but fail to meet the requirements of TB 603. Such a mattress would be characterized as FR for purposes of 16 CFR §1632 but non-FR for purposes of TB 603. Taken as a class, however, all FR products tend to minimize the amount and rate of heat released from the product upon contact with an open flame or other source of ignition. The rate of heat released by an FR product is generally viewed as both an indication of the intensity of the fire generated by the FR product as well as how quickly the fire will spread. Slowing the spread of fire advantageously increases the amount of response time for a person in dangerous proximity to the fire to move to a place of safety and for a fire department or other public or private safety agency to successfully extinguish the fire.

In the bedding, upholstery and other industries, foams and nonwoven fibers are often used in mattresses, sofas, chairs, and seat cushions, backs and arms. Traditionally, urethane foam has been combined with other types of cushioning materials such as cotton batting, latex rubber, and various nonwoven fibers in order to impart desirable comfort, loft and durability characteristics to a finished product. However, urethane foam is extremely flammable and must be chemically treated or coated to impart FR properties thereto. As it is widely recognized as having FR properties, neoprene foam is often used in bedding and upholstery products as well. However, as both neoprene foam and urethane foam which has been chemically treated to impart FR properties thereto are relatively expensive, cost constraints often limit the applications for which neoprene foam and chemically treated urethane are commercially suitable.

Synthetic and natural woven fibers are often used to construct mattresses and upholstery. Such fibers are inherently lightweight and therefore easy to ship, store and manipulate during processing. Many will also resist burning and are, therefore, useful when manufacturing FR mattresses and upholstery. For example, when subjected to high temperatures, many synthetic fibers, particularly polymer fibers and specifically dry polyester fibers, tend to (1) melt and drip rather than burn and (2) physically retreat (or “shrink away”) from an open flame or other source of heat. As used herein, the term “heat-reactive-type fibers” shall refer to those fibers which undergo a physical displacement, away from an open flame or other source of heat, upon application of the open flame or other source of heat thereto. For example, the aforedescribed response of polyester fibers to heat clearly establishes polyester fiber as a heat reactive-type fiber. It should be clearly understood, however, that the foregoing is provided purely by way of example and that there are a wide variety of types of fibers other than those specifically identified herein which may properly be identified as heat-reactive type fibers suitable for the uses contemplated herein.

However, the use of polyester fibers alone does not always provide mattresses or upholstery with sufficient protection from fire. As a result, the use of other fibers has also been proposed. As used herein, the term “inherent-type FR fibers” refers to those fibers which resist combustion as a result of an essential characteristic of the fiber. Conversely, the term “non-inherent-type FR fibers” refers to those fibers that are generally considered to be non-FR but have been treated with a fire retardant to become FR. As further used herein, the term “charring fibers” refers to fibers that resist combustion and instead form a stable structure in response to exposure of the fibers to an open flame. Both inherent-type FR fibers and non-inherent-type FR fibers may be charring fibers. Periodically, charring fibers are referred to as “barrier fibers” in that a nonwoven fiber batt which incorporates charring fibers as a component thereof often serves as a barrier which shields underlying components from the open flame causing the fibers of the nonwoven fiber batt to char.

To enhance the FR characteristic thereof, one FR fiber that has been proposed for use as a component of nonwoven fiber batts typically found in mattresses, upholstery or the like is a fiber commonly known as oxidized polyacrylonitrile (PAN). When exposed to an open flame, oxidized PAN forms a stable char structure. As a result, an FR nonwoven fiber batt incorporating oxidized PAN as a component thereof would maintain its structural integrity for a longer period of time, thereby enabling the FR nonwoven fiber batt to serve as a barrier which shields underlying components from the open flame. Thus, oxidized PAN may be properly identified as either a charring or barrier fiber. Further, as the FR characteristic of oxidized PAN results from an essential characteristic thereof, oxidized PAN may be further properly identified as either an inherent-type FR charring fiber or an inherent-type FR barrier fiber. It should be clearly understood, however, that the foregoing is provided purely by way of example and that there are a wide variety of fibers other than those specifically identified herein may properly be identified as either inherent-type FR fibers or non-inherent type FR fibers suitable for the uses contemplated herein.

One obstacle to the use of oxidized PAN as a component of inherent-type FR nonwoven fiber batts such as those used in many mattress, upholstery and other nonwoven fiber applications is that its high cost may result in products that are too expensive to successfully compete in the marketplace. Another drawback is that the oxidized PAN fibers themselves are difficult to process into fiber batts for use as a barrier layer and/or filling. As a result, oxidized PAN fibers are not always particularly well suited for use in the aforementioned applications. More specifically, as oxidized PAN fibers are relatively low in weight and specific gravity, traditional carding methods used to form nonwoven fiber batts are much more difficult. In addition, oxidized PAN fibers are so-called dead fibers as they have relatively little resilience and loft and are generally incompressible. As a result, nonwoven fiber batts formed using oxidized PAN fibers are often unsuitable for those bedding, upholstery and other applications where loft and comfort are desired. Finally, oxidized PAN fibers are also black in color and may, therefore, be unsuitable in applications where aesthetics are of particular concern, for example, in products which require a light color beneath a light decorative upholstery or mattress layer.

Various solutions to the use, in nonwoven fiber batts, of FR fibers having one or more of the shortcomings associated with the use of oxidized PAN fibers have been proposed. For example, International Publication No. WO 01/6834 A1 to Ogle et al. discloses a method of forming a bi-layer nonwoven fire combustion modified batt for use in a mattress. The fire combustion modified batt disclosed in WO 01/6834 is comprised of a first, FR, layer formed from a first blend of black oxidized PAN fibers and nonwoven fibers, specifically, white polyester carrier fibers and white polyester binder fibers and a second layer formed from a second blend of nonwoven fibers, specifically, white polyester carrier fibers and white polyester binder fibers. The resultant fire combustion modified batt has a distinctly gray colored side (the oxidized PAN layer) to be disposed above any other interior components of the mattress and a distinctly white, outwardly facing side (the nonwoven fiber layer) to be disposed against the ticking of the mattress. By positioning the bi-layer nonwoven fire combustion modified batt such that the grey oxidized PAN layer is disposed against the interior components of the mattress and the white polyester layer is disposed against the ticking of the mattress, the white nonwoven fiber layer shields the gray oxidized PAN layer from sight, thereby preventing the grey oxidized PAN layer from detracting from the aesthetics of the mattress.

When exposed to an open flame, the heat-reactive polyester fibers of the outer, nonwoven fiber layer rapidly retreat away from the flame, quickly exposing the inner, oxidized PAN layer to the open flame. Likewise, when exposed to the open flame, the polyester fibers of the oxidized PAN layer also retreat rapidly away from the flame. Here, however, the retreat of the polyester fibers results in the creation of a layer of inert oxidized PAN that acts as a flameproof shield against the exothermic oxidation of any combustible material located beneath the oxidized PAN layer, thereby enhancing the FR characteristic of the mattress. The oxidized PAN layer acts as a shield which protects underlying combustible material from coming into contact with the open flame. The retreat of the polyester fibers may weaken this shielding barrier layer, however. Additionally, while shielding the combustible material from direct contact with flame, the barrier/charring layer would perform better if the intensity of the flame could be reduced.

What is sought, therefore, is a an improved FR barrier serving as a more durable and effective flame barrier which may shield combustible materials disposed thereagainst while also reducing the intensity of the flame.

### SUMMARY

In one aspect, the present disclosure is directed to a fire resistant (“FR”) barrier, comprising: an FR nonwoven fiber batt having a first side surface and a second side surface, said FR nonwoven fiber batt formed from a homogeneous fiber blend comprising FR fibers and carrier fibers; and an FR chemical barrier layer, wherein said chemical barrier layer is applied to said first side surface of said FR nonwoven fiber batt. In an embodiment, said homogeneous fiber blend further comprises binder fibers. In another embodiment, said FR nonwoven fiber batt further comprises resin operable to bond said homogenous fiber blend together. Said carrier fibers may comprise polyester carrier fibers and said binder fibers may comprise polyester binder fibers.

In yet another embodiment, said chemical barrier layer comprises oxygen depleting chemicals. Alternatively, said chemical barrier layer may comprise phosphorus-based FR chemicals, or multipolyphosphate. In still another embodiment, said FR fibers are operable to neither melt nor flow when in contact with heat or flame. Said FR fibers may comprise inherently FR fibers, and said inherently FR fibers may comprise durable FR rayon or Visil® fibers. Alternatively, said FR fibers may comprise non-inherently FR fibers treated with a fire retardant chemical, and said non-inherently FR fibers may comprise cellulosic fibers selected from the group consisting of rayon, cotton, jute, shoddy, wool, and silk.

In another aspect, the present disclosure is directed to a product incorporating the FR barrier of claim 1, said product having a combustible layer, wherein said second side surface of said FR nonwoven fiber batt is disposed in proximity to the combustible layer. Said product may be selected from the group consisting of mattresses, bed clothing, and automotive firewalls.

In still another aspect, the present disclosure is directed to a method for forming a fire resistant (“FR”) barrier, comprising: forming a homogeneous blend of fibers comprising FR fibers and carrier fibers; forming an FR nonwoven fiber batt from said homogeneous blend of fibers, wherein said FR nonwoven fiber batt has a first side surface and a second side surface; and applying an FR chemical barrier layer to said first side surface of said FR nonwoven fiber batt. In an embodiment, applying the FR chemical barrier layer comprises spraying oxygen depleting chemicals onto the first side surface. Alternatively, applying the FR chemical barrier layer may comprise foaming oxygen depleting chemicals onto the first side surface.

In another embodiment, said homogeneous blend of fibers further comprises binder fibers, and forming the FR nonwoven fiber batt comprises thermally bonding the binder fibers to the FR fibers, the carrier fibers, and to each other. Still another embodiment further comprises treating non-inherently FR fibers with a fire retardant chemical to form the FR fibers. Said FR barrier may be used with a product having a combustible layer, said method further comprising disposing said second side surface of said FR nonwoven fiber batt in proximity to the combustible layer of the product.

### DESCRIPTION OF THE DRAWINGS

For a more complete understanding of the present invention, and for further details and advantages thereof, reference is now made to the accompanying drawings, in which:

FIG. 1 is a flow chart of a method of forming an FR barrier having a chemical barrier layer applied to an FR nonwoven fiber batt in accordance with the teachings disclosed herein;

FIG. 2 is a schematic top plan view of a processing line for forming the FR barrier in accordance with the method of FIG. 1;

FIG. 3A is a schematic side view of a thermal bonding apparatus forming part of the processing line of FIG. 2;

FIG. 3B is a schematic side view of a thermal bonding apparatus suitable for use in place of the thermal bonding apparatus of FIG. 3A;

FIG. 4 is a partially cutaway view of a mattress which incorporates the FR barrier formed in accordance with the method of FIG. 1;

FIG. 5A is an expanded partial side view of the FR barrier of FIG. 4;

FIG. 5B is an expanded partial side view of an alternate embodiment of the FR barrier of FIG. 5A;

FIG. 5C is an expanded partial side view of an alternative embodiment of the FR barrier having a chemical barrier layer, a barrier layer FR nonwoven fiber batt, and a heat reactive layer batt;

FIG. 6A is a cross-sectional view of the FR barrier of FIG. 5A which representatively illustrates the manner in which the FR barrier of FIGS. 4 and 5A-B may shield a combustible layer of a product from an open flame applied thereto; and

FIG. 6B is a cross-sectional view of the FR barrier of FIG. 5C which representatively illustrates the manner in which the FR barrier of FIG. 5C may shield and insulate a combustible layer of a product from an open flame applied thereto

### DETAILED DESCRIPTION

It should be clearly understood that the teachings set forth herein are susceptible to various modifications and alternative forms, specific embodiments of which are, by way of example, shown in the drawings and described in detail herein. It should be clearly understood, however, that the drawings and detailed description set forth herein are not intended to limit the disclosed teachings to the particular form disclosed. On the contrary, the intention is to cover all modifications, equivalents and alternatives falling within the spirit and scope of that which is defined by the claims appended hereto.

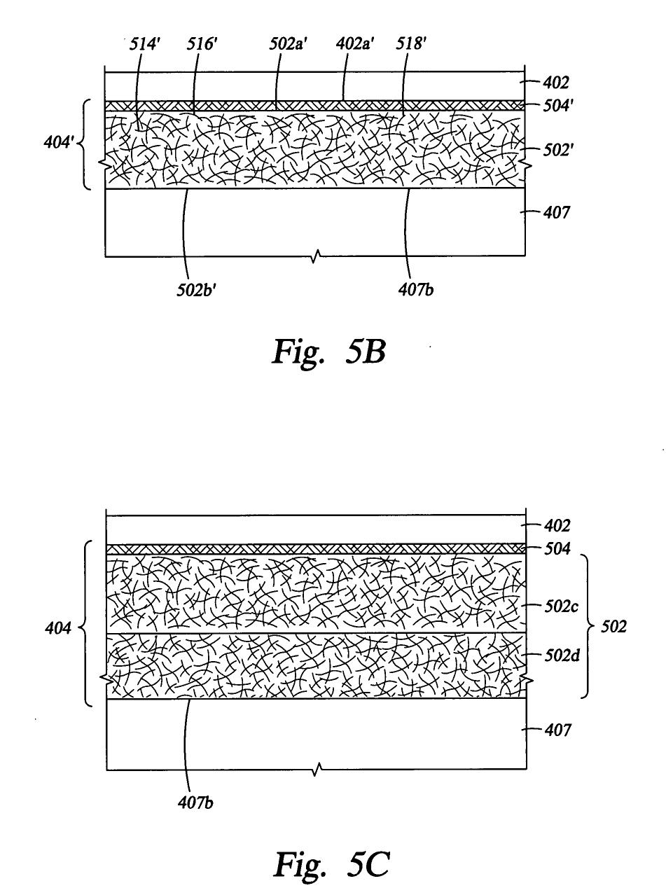

The method for forming an FR barrier 404 will now be described in greater detail. In the general example set forth in FIG. 5A, the FR barrier 404 comprises an FR nonwoven fiber batt 502 and a chemical barrier layer 504. Thus, the formation of the FR barrier 404 generally includes formation of an FR nonwoven fiber batt and application of a chemical barrier layer. By way of example, the process set forth in detail hereinbelow includes a thermal bonding process (using bonding fibers to form the FR nonwoven batt). It should be clearly understood, however, that a resin saturated curing process may be employed in place of the disclosed thermal bonding process. It should be further understood that a variety of other bonding processes, for example, needle-punching, hydro-entangling and mechanical bonding, may also be suitable for bonding fibers together to form the disclosed FR nonwoven fiber batt used within the FR barrier of the present invention. Indeed, in certain applications, it may be beneficial to use multiple bonding processes when forming the FR nonwoven batt. Finally, it should be noted that the disclosed process for forming the FR nonwoven fiber batt of the FR barrier 404 is similar to the processes used to form a variety of other FR nonwoven fiber batts, for example, the FR nonwoven fiber batts disclosed in, among others, our co-pending U.S. patent application Ser. Nos. 10/221,638, 10/968,318, 10/968,339, 11/088,657, and co-filed ______, 4003-21502 (entitled “Heat Absorptive Bi-Layer Fire Resistant Nonwoven Fiber Batt”), all of which are assigned to the Assignee of the present application and hereby incorporated by reference as if reproduced in their entirety.

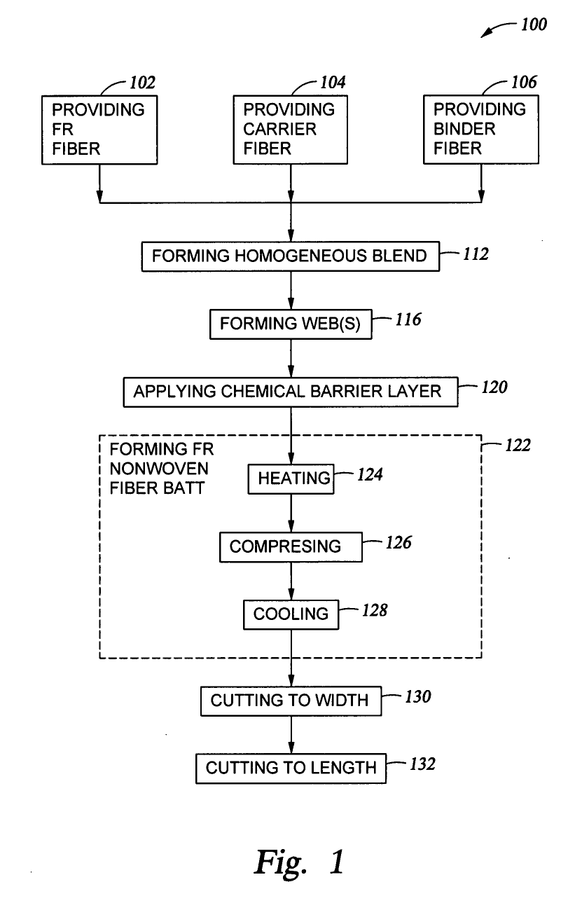

Referring now to FIG. 1, an exemplary process for forming an FR barrier 404, including a thermal bonding process used to form an FR nonwoven fiber batt 502 and application of a chemical barrier layer 504, will now be described in greater detail in accordance with the teachings of the present invention. As may now be seen, the process 100 of forming the FR barrier 404 begins with formation of the FR nonwoven fiber batt 502. Components are provided to be used to form a web. Accordingly, first, second and third types of fibers are provided at 102, 104 and 106, respectively. The first type of fiber provided at 102 is an FR fiber, the second type of fiber provided at 104 is a carrier fiber and the third type of fiber provided at 106 is a binder fiber. Preferably, the FR fiber is a barrier-type fiber.

In one embodiment, the barrier-type fiber is a charring fiber (as shown in the example of FIG. 1). It is fully contemplated that a wide variety of charring fibers are suitable for the purposes disclosed herein. As previously set forth, a charring fiber is a fiber which, when exposed to an open flame, forms a stable char structure which enables an FR nonwoven fiber batt incorporating the charring fiber as a component thereof to maintain its structural integrity for a longer period of time, thereby enabling the FR nonwoven fiber batt to serve as a flame barrier. In the example of FIG. 1, if a charring fiber is to be deployed as the barrier-type fiber, the charring fiber of choice is the treated cellulosic fiber commonly known as FR rayon. As used herein, the term “FR rayon” refers to rayon fibers treated by applying a suitable flame retardant chemical thereto, thereby effectively rendering the rayon fibers FR or, more specifically, non-inherently FR. FR rayon is particularly well suited for the purposes disclosed herein as it is a white fiber which, unlike black FR fibers such as oxidized PAN, will not adversely affect the aesthetics of a product which incorporates an FR nonwoven fiber batt having FR rayon as a component thereof.

If FR rayon is employed as a component of the web, the FR rayon of choice is a durable FR rayon such as that disclosed in our co-pending provisional U.S. Patent Application Ser. No. 60/813,378 (Atty. Docket No. 4003-08201), hereby incorporated by reference as if reproduced in its entirety. In that durable FR rayon fibers tend to better maintain their FR characteristic, durable FR rayon fibers are generally preferred over non-durable FR rayon fibers since the FR characteristic of the fiber will resist degradation over time While, as disclosed herein, durable FR rayon fibers are provided at 102, it is fully contemplated that, in an alternate embodiment not disclosed herein, the FR rayon fibers provided at 102 may be non-durable FR rayon fibers which are subsequently rendered durable during formation of the FR barrier. Of course, other charring fibers may be used at 102, or alternatively, other FR fibers could be provided. The process by which nondurable FR rayon fibers are rendered durable during the batt formation process is set forth in greater detail in the aforementioned co-pending provisional U.S. Patent Application Ser. No. 60/813,378 (Atty. Docket No. 4003-08201).

In another embodiment, it is contemplated that the FR barrier-type fibers to be employed are hybrid fibers, e.g., fibers that are part organic and part inorganic, for example, viscose staple fibers containing silicic acid is a hybrid fiber. One such fiber is Visil®, an FR fiber commercially available through Sateri Oy of Valkeakoski, Finland. Visil® is a permanently FR fiber that neither melts nor flows when in contact with heat or flame and is described in greater detail in U.S. Pat. No. 5,417,752, which is hereby incorporated by reference as if reproduced in its entirety.

In still other embodiments, it is contemplated that the FR fiber may be an inherently FR fiber, for example, oxidized polyacrylonitrile (PAN) or a non-inherently FR fiber (in which a fire retardant chemical is applied to non-FR fibers). Of course, while oxidized PAN is an inherently FR fiber functionally suitable for the purposes disclosed herein, its use is generally discouraged in view of its relatively high cost and dark color. Of course, the foregoing is but one example of a inherently FR fiber suitable for the purposes disclosed herein. Conversely, if a non-inherently FR fiber is selected, it is generally preferred that the fiber is processed to be a durable non-inherently FR fiber, for example, using the aforementioned process disclosed in provisional U.S. Patent Application Ser. No. 60/813,378 (Atty. Docket No. 4003-08201).

Typically, non-inherently FR fibers begin as conventional, i.e., non-FR, fibers, which are then treated with an FR chemical compound, most commonly, by either impregnated or coating the non-FR fibers with the FR chemical compound. Variously, the FR chemical compound may be wash durable or non-wash durable. Examples of wash durable FR chemical compounds suitable for the uses contemplated herein include the X-12 chemical compound manufactured by E.I. duPont de Nemours and Company of Wilmington, Del., the GUARDIAN series of specialty flame retardancy chemical compounds manufactured by Glo-Tex International, Inc. of Spartanburg, S.C. and the FR chemical compound disclosed in U.S. Pat. No. 3,997,699 entitled “Flame Resistant Substrates” and hereby incorporated by reference as if reproduced in its entirety. While it is contemplated that the FR chemical compound used to treat the FR fibers may be non-wash durable, non-wash durable treatments are not preferred because they lose the FR effectiveness when washed. Examples of non-wash-durable fibers may include FR viscose, such as VISIL® available from Sateri Oy and LENZING FR® available from Lenzing AG. Any of the fibers described above may also be treated with other chemicals such as antimicrobial chemicals, antioxidants, or dyes. The example fibers and FR chemicals set forth above are merely exemplary, and non-inherently FR fibers may comprise other fibers and FR chemicals, which are inherently included within the scope of this disclosure. After being treated with one or more fire retardant chemicals, the fibers (which by way of example may be cellulosic fibers such as rayon, cotton, jute, shoddy/recycled, wool, or silk) exhibit FR characteristics. A combination of various types of FR fibers could also be used in the barrier layer, with the various FR fibers homogeneously blended with the carrier and/or binder fibers.

As may be further seen in FIG. 1, the nonwoven fibers respectively provided at 104 and 106 and subsequently used, in combination with the charring fibers (which may, by way of example, be FR rayon fibers) provided at 102, to form the generally homogeneous blend at 112 include carrier fibers and binder fibers. Variously, the carrier and binder fibers can be natural or synthetic fibers. For example, thermoplastic polymer fibers such as polyester are synthetic fibers suitable for use as both the carrier and binder fibers. Of course, depending on the precise processing limitations imposed on the manufacturing process and the characteristics of the web formed at 116, other fibers may be suitable for the purposes contemplated herein.

In one embodiment, it is contemplated that a suitable fiber for use as the carrier fiber would be a Type 209 polyester fiber manufactured by KoSa of Wichita, Kans., or an equivalent. The Type 209 polyester fiber is a white fiber having a weight-per-unit-length of between 6 and 15 denier, a cut length of between 2 and 3 inches in length and a round, hollow, cross-section. Alternately, the carrier fiber may be a Type 295 polyester fiber, also manufactured by KoSa, or an equivalent. The Type 295 polyester fiber is a white fiber having a weight-per-unit-length of between 6 and 15 denier, a cut length of between ⅕ and 4 and a pentalobal cross-section. Carrier fibers typically are either hollow or solid (depending on functional needs such as loft). Preferably, the carrier fibers for this example would be optically bright for aesthetic purposes (since this may help to preserve a white product appearance even if the FR fiber has some other color or tint). Carrier fibers typically provide loft, provide resilience, provide structure, and/or allow effective formation of batts using traditional carding techniques. Of course, the foregoing disclosure of particular carrier fibers (and/or carrier fiber characteristics) is purely for purposes of illustration and should not be construed as a limitation in any manner. In this regard, it is fully contemplated that other nonwoven fibers are suitable for use as carrier fibers and are, therefore, within the scope of the present disclosure.

The binder fiber has a lower predetermined melting temperature relative to the predetermined melting temperature of the carrier fiber. It is an inherent characteristic of thermoplastic fibers such as polyester that they become sticky and tacky when melted, as that term is used herein. For purposes of illustrating the process by which the FR nonwoven fiber batt is constructed, in the embodiment disclosed herein, it is contemplated that the binder fiber may be a Type 254 Celbond® polyester fiber, also manufactured by KoSa, or an equivalent. The Type 254 Celbond® polyester fiber is a bicomponent fiber with a polyester core and a copolyester sheath having a melting temperature of approximately 230° F. (110° C.). Of course, the foregoing disclosure of a particular binder fiber is purely for purposes of illustration and should not be construed as a limitation in any manner. In this regard, it is fully contemplated that other nonwoven fibers are suitable for use as binder fibers and are, therefore, within the scope of the present disclosure. For example, it is contemplated that a polyester copolymer binder fiber is suitable for use in place of the bicomponent binder fiber hereinabove disclosed. In some embodiment, it may also be possible to use a liquid adhesive/resin in place of binder fibers in order to bind the fibers together into a batt. Binder fibers are typically preferred, since they have good flammability characteristics (while such liquid adhesives are often quite flammable). If a liquid adhesive/resin (such as latex or PVC based adhesives) is used, it may be necessary to also employ an additive that reduces flammability (although such an additive would drive up costs).

Proceeding on to 112, the white charring fibers provided at 102, the white polyester carrier fibers provided at 104 and the white polyester binder fibers provided at 106 are mixed to form a generally homogeneous blend. As used herein, the term “homogeneous” means generally or approximately homogeneous, such as a blend in which the various types of fibers are dispersed throughout fairly uniformly (without large concentrations of one particular fiber, for instance). While there may be some amount of compositional variation, such variation tends to have relatively little impact on effective characteristics. Thus, a homogeneous blend, as used herein, would tend to have similar characteristics throughout. In the embodiment disclosed herein, it is contemplated that the blend may be comprised of binder finders in an amount sufficient for binding the fibers of the blend together upon application of heat at the appropriate temperature to melt the binder fibers. In one example, the binder fibers are in the range of approximately 5 percent to 50 percent by total volume of the blend. Preferably, the binder finders are present in the range of approximately 10 percent to 15 percent by volume for a high loft FR nonwoven fiber batt and in the range of approximately 15 percent to 40 percent by volume for a densified FR nonwoven fiber batt. The selection of a high loft batt or a densified batt may depend on the specific use of the batt, and particularly the specific type of article for which the batt will be used. The relative percent volume of charring fibers to carrier fibers in the remaining volume of the first blend may range from 15 percent to 85 percent. In the preferred embodiment, the relative percent volume of charring fibers to carrier fibers in the remaining volume of the first blend is about 50 percent to 50 percent. Thus, for example, a blend having 10 percent by volume of binder fibers and a 50 to 50 percent relative volume of charring fibers to carrier fibers in the remaining volume of the blend, the volume of charring fibers and carrier fibers in the blend is 45 percent each.

In another example, for a blend having 20 percent by volume of binder fibers and a 50 to 50 percent relative volume of charring fibers to carrier fibers in the remaining volume of the blend, the volume of charring fibers and carrier fibers is 40 percent each. In still another example, for a blend having 20 percent by volume of binder fibers and a 75 to 25 percent relative volume of charring fibers to carrier fibers in the remaining volume of the blend, the volume of charring fibers and carrier fibers in the blend is 60 percent and 20 percent, respectively. Of course, it is fully contemplated that blends having other percentages of binder, charring and carrier fibers are also within the scope of the invention. It is further contemplated that blend need not necessarily include each of the aforementioned binder, carrier and charring fibers. For example, in some instances, it may be suitable to form the blend of fibers without the inclusion of carrier fibers therein. Alternatively, it may be suitable in some instances to form the blend of fibers without inclusion of binder fibers therein, if for example, some other bonding process is used to form the batt.

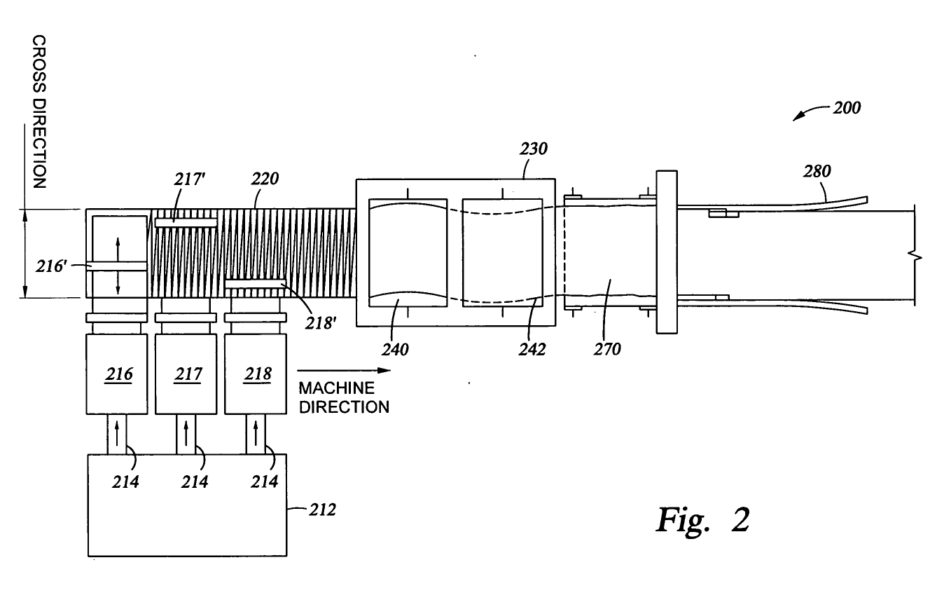

Referring next to FIG. 2, a schematic top plan view of a processing line 200 for forming an FR nonwoven fiber batt will now be described in greater detail. It should be noted, however, that the description which follows is directed to the formation of a web generally and not to formation of any particular type. Accordingly, the description which follows is applicable to formation of an exemplary web from a generally homogeneous blend of charring fibers, polyester carrier fibers and polyester binder fibers, by way of example.

As set forth hereinbove, the specified types of fibers are blended in a fiber blender 212 and conveyed by conveyor pipes 214 to a web forming device or, in the embodiment disclosed herein, first, second and third web forming devices 216, 217 and 218. It is contemplated that a gamett machine is a suitable type of web forming device. Of course, it is fully contemplated that other types of web forming devices would be suitable for the purposes contemplated herein. For example, an air laying device, commonly known in the art as a Rando webber may be used to form the web. In the embodiment disclosed herein, the first, second and third web forming devices 216, 217 and 218 card the blended fibers into a nonwoven web having a desired width and deliver the nonwoven web to a corresponding one of first, second and third cross-lappers 216′, 217′, 218′ to cross-lap the nonwoven web onto a slat conveyor 220 moving in the machine direction. First, second and third cross-lappers 216′, 217′ and 218′ reciprocate back and forth in the cross direction from one side of the slat conveyor 220 to the other to form a nonwoven web having multiple thicknesses in a progressive overlapping relationship.

The number of layers which make up the nonwoven web is determined by the speed of the slat conveyor 220 in relation to the speed at which successive layers of the nonwoven web are layered on top of each other and the number of cross-lappers employed as part of the processing line 200. Thus, the number of single layers which collectively make up the nonwoven web can be increased by slowing the relative speed of the slat conveyor 220 in relation to the speed at which the first, second and third cross-lappers 216′, 217′ and 218′ reciprocate, by increasing the number to exceed the three cross-lappers 216′, 217′, 218′ currently shown or both. Conversely, a nonwoven web having a lesser number of single layers can be achieved by increasing the speed of the slat conveyor 220 relative to the speed at which the first, second and third cross-lappers 216′, 217′ and 218′ reciprocate, by reducing the number of cross-lappers below the three cross-lappers 216′, 217′, 218′ currently shown or both.

Referring back to FIG. 1, for the configuration of the FR nonwoven fiber batt, the process 100 includes forming a web at 116 (as described above in the example of FIG. 2). In the example of FIG. 1, an FR chemical barrier layer is applied next at 120. While the FR chemical barrier layer could be applied at different stages in the batt formation process, in the example of FIG. 1 the FR chemical barrier layer is applied to the web, and then the batt is formed from the web (by heating at 124 and compression at 126). The FR chemical barrier layer is generally applied by either spraying and/or foaming oxygen depleting chemicals onto one or more surfaces of the nonwoven web. Preferably, oxygen depleting chemicals are applied to only one side surface of the web (which will ultimately become the distal/exterior side surface with respect to the combustible layer being protected). The oxygen depleting chemicals of the chemical barrier layer may be phosphorous-based, by way of example, since these chemicals tend to off-gas when heated, emitting non-flammable chemicals that displace oxygen (thereby reducing the intensity of any flame), and since these chemicals are a “green” option (that may be non-carcinogenic and safe for use in bedding products). A specific, non-exclusive example of an oxygen depleting chemical for FIG. 1 would be multipolyphosphate. Other types of oxygen depleting chemicals (such as bromides, for example) could be used in the chemical barrier layer, although preferably they should also be “green.”

In the example of FIG. 1, a sufficient amount of oxygen depleting chemical is sprayed and/or foamed onto a surface of the nonwoven web so that, when dried, the oxygen depleting chemicals are at least about 5% by weight of the batt. In one embodiment, the oxygen depleting chemicals are at least about 10% by weight, and in another embodiment they are between about 5% and about 10% by weight. In the example of FIG. 1, the oxygen depleting chemicals are cured by heating at 124 (during formation of the batt). Alternatively, however, the oxygen depleting chemicals could be cured at room temperature (without additional heat) as the water evaporates to leave deposited chemicals on the surface of the batt.

After the chemical barrier layer has been applied at 120 in FIG. 1, the FR nonwoven fiber batt is then generally formed using a bonding process on the web. While it is fully contemplated that a variety of thermal bonding processes may be used as part of the formation of the FR nonwoven fiber batt at 122 from the web, one such method comprises holding the web in place using vacuum pressure applied through perforations of first and second counter-rotating drums and heating the web so that the relatively low melting temperature binder fibers in the web soften or melt to the extent necessary to fuse the low melt binder fibers together and to the FR fibers and the carrier fibers of the web. Alternatively, the web may be moved through an oven which melts the low temperature binder fibers of the web using substantially parallel perforated or mesh wire aprons. And as stated above, alternative bonding methods could be employed to bond the homogeneous fiber blend of the web(s) together into an FR nonwoven fiber batt 502.

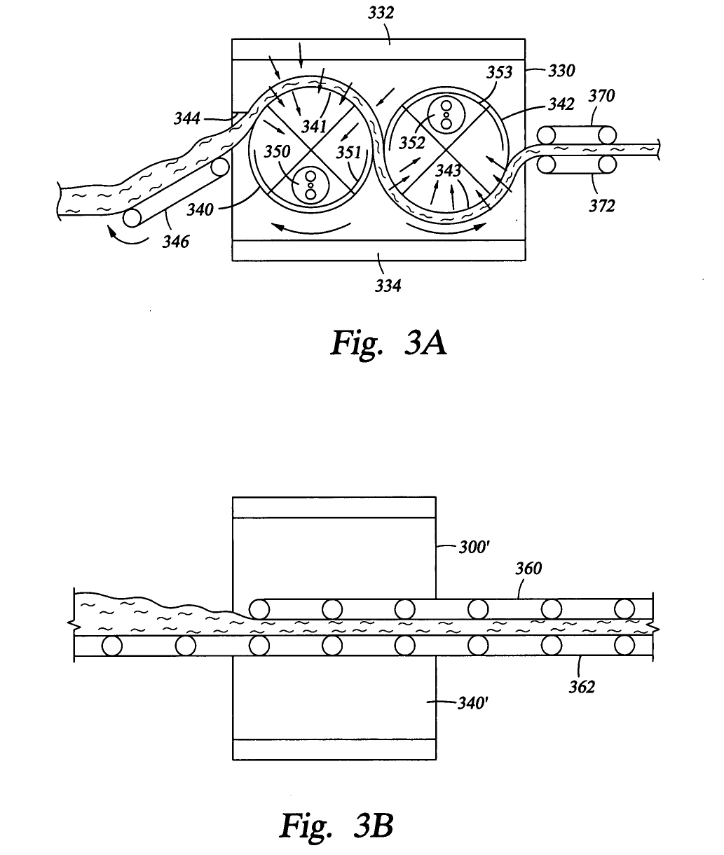

Referring collectively to FIGS. 2 and 3A, the thermal bonding process which utilizes vacuum pressure to construct the neat FR nonwoven fiber batt disclosed herein will now be described in greater detail. As may now be seen, counter-rotating drums 340, 342, each having perforations 341, 343, respectively, are positioned in a central portion of a housing 300. If desired, the drums 340, 342 may be mounted for lateral sliding movement relative to one another, thereby facilitating the adjustment of the drums 340, 342 for a wide range of web thicknesses. Typically, lateral sliding of the drums 340, 342 is enabled using additional components not shown in FIG. 3A. The housing 300 further includes an air circulation chamber 332 in an upper portion thereof and a furnace 334 in a lower portion, thereof. The drum 340 is positioned adjacent an inlet 344 though which the web is fed. More specifically, an infeed apron 346 delivers the web to the drum 340. As the drum 340 rotates in a clockwise direction, a suction fan 350 in communication with the interior of the drum 340 creates an air flow which enters the drum 340 through the perforations 341 proximate the upper portion of the drum 340. In the meantime, a baffle 351 shields the lower portion of the drum 340, thereby preventing the air flow from also entering the drum 340 through the perforations proximate the lower portion of the drum 340.

The drum 342 is downstream from the drum 340 in housing 300. Similar to the drum 340, the drum 342 includes a suction fan 352 in communication with the interior of the drum 342 and a baffle 353. As the drum 342 rotates in a counterclockwise direction, the suction fan 352 creates an air flow which enters the drum 340 through the perforations 343 proximate the lower portion of the drum 342. In the meantime, the baffle 352 shields the upper portion of the drum 342, thereby preventing the air flow from also entering the drum 342 through the perforations proximate the upper portion of the drum 340.

The web is held in vacuum pressure as it moves from the upper portion of the clockwise rotating drum 340 to the lower portion of the counterclockwise rotating drum 342. As the air in the housing 300 flows through the perforations 341, 343 into the respective interiors of the drums 340, 342, the furnace 334 heats the air, to soften or melt the relatively low melting temperature binder fibers included in the web to the extent necessary to fuse the low melt binder fibers together and to the carrier and charring fibers in the web. This heating is shown in 124 of FIG. 1.

Referring next to FIG. 3B, in an alternative thermal bonding process, a pair of substantially parallel perforated or mesh wire aprons 360, 362 feed the web into housing 300′. The housing 300′ includes an oven 340′ which heats the web to soften or melt the relatively low melting temperature binder fibers included in the web to the extent necessary to fuse the low melt binder fibers together and to the carrier and charring fibers in the web.

Next, referring collectively to FIGS. 2 and 3A, as the FR nonwoven fiber batt is transported out of the housing 300 by a pair of substantially parallel first and second perforated or wire mesh aprons 370, 372, the FR nonwoven fiber batt is compressed and cooled. Compression and cooling is shown in 126 and 128 of FIG. 1. If desired, the aprons 370, 372 may be mounted for parallel movement relative to one another, thereby facilitating the adjustment of the aprons 370, 372 for a wide range of batt thicknesses. Variously, the FR nonwoven fiber batt may be slowly cooled through exposure to ambient temperature air or, in the alternative, ambient temperature air can forced through the perforations of one apron 370, 372, through the FR nonwoven fiber batt and then through the perforations of the other apron 370, 372 to cool the FR nonwoven fiber batt and set it in its compressed state. The solidification of the low melt temperature binder fibers in the web bonds the low melt binder, carrier and charring fibers to one another. Thusly, the resultant FR nonwoven fiber batt is capable of maintaining its compressed state.

The thickness of the finished, fully formed FR nonwoven fiber batt (formed from the nonwoven web layers at 122) typically would depend upon the specific uses of the batt and/or the density of the batt. Generally, the density of the fully formed batt would be between about 0.5 to about 1.0 ounce per square foot (since this effectively balances performance and loft), and the thickness of the formed batt would be between about 0.25 to about 1.0 inch. Generally the thickness of the fully formed batt of FIG. 1 is driven by mattress industry needs (regarding comfort, for example), and the thickness of the batt would preferably be between about 0.5 and about 1.0 inches when used on the top surface of a mattress, and would be between about 0.25 and about 0.75 inches when used on the border (side surfaces) of a mattress.

Referring again collectively to FIGS. 1 and 2, the now cooled, FR nonwoven fiber batt with chemical barrier layer (FR barrier) is transported to cutting zone 280. There, the lateral edges of the FR barrier batt 404 are trimmed at 130 to a finished width. Similarly, the FR barrier batt 404 is also cut transversely to a desired length at 132.

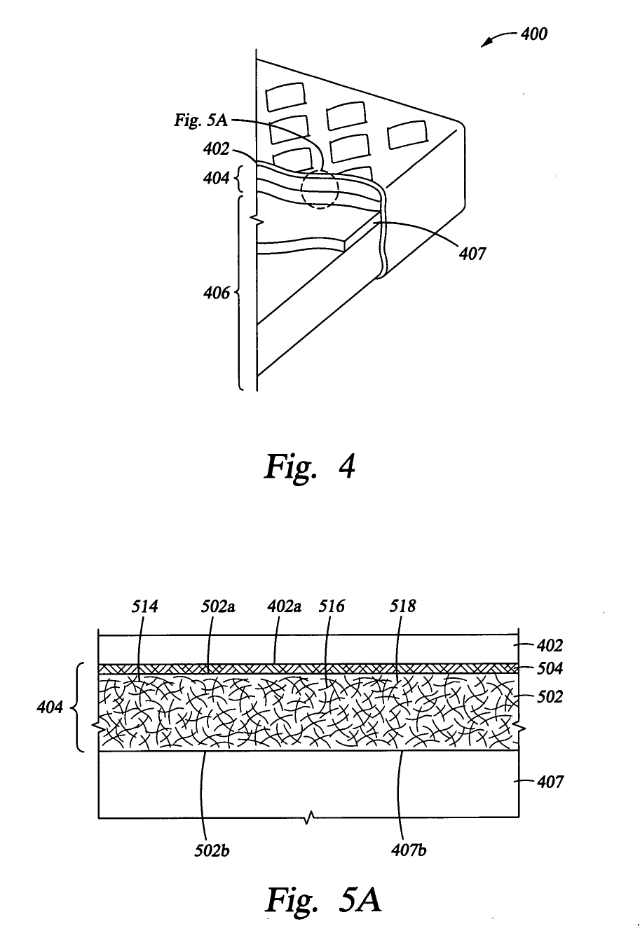

Referring next to FIG. 4, a mattress 400 which includes a FR barrier 404 will now be described in detail. Of course, the mattress 400 is but one of a wide variety of products in which the FR barrier 404 is suitable for incorporation therein. By way of alternate example, the FR barrier 404 could also be used in bed clothing (such as mattress covers, comforters, and quilts) and automotive firewalls. Accordingly, the disclosure of the FR barrier layer 404 as being incorporated into the mattress should in no way be construed as a limitation as to the type of products in which the FR barrier layer 404 may be deployed. For ease of comprehension, the foregoing description of the mattress 400 has been greatly simplified and a variety of the components which typically form part of a conventionally configured mattress have either been combined with one or more other conventional components of the matters are have been entirely omitted from the description that follows.

As may be seen in FIG. 4, the mattress 400 may, in a broad sense, be characterized as being comprised of three components-a ticking 402, an FR barrier 404, and a mattress core 406. As defined herein, the mattress core 406 is the combination of a wide variety of components which collectively form the mattress 400. While the mattress core 406 may include a combination of combustible and non-combustible components, for the purposes disclosed herein, the mattress core 406 shall be considered to be a combustible component of the mattress 400. The ticking 402 covers all other components of the mattress 400 and is typically formed of a durable, closely woven fabric. As the ticking 402 is that portion of the mattress 400 visible to a consumer and/or end user of the mattress 400, the ticking 402 is typically formed in a manner intended to result in a pleasing appearance. Thus, tickings are often woven in a plain, satin, or twill weave, usually with strong warp yarns and soft filling yarns.

The FR barrier 404 is positioned between the mattress core 406 and the ticking 402 (and specifically is shown in FIG. 4 between the combustible component layer 407 of the mattress core 406 and the ticking 402). As shown in FIG. 4, the FR barrier 404 may cover the top and side surfaces of the mattress core 406, with a lower side surface of the mattress core 406 remaining uncovered. In an alternate embodiment not specifically shown in FIG. 4, the FR barrier 404 is wrapped around the entire mattress core 406.

In still another alternate embodiment not specifically shown in FIG. 4, the FR barrier 404 is merely positioned between a layer forming part of the mattress core 406 and the ticking 402. For example, the mattress core 406 may include a soft, relatively plush, layer 407 provided to enhance the comfort of the mattress 400. However, depending on its specific composition, it is entirely possible that the layer 407 is considered to be combustible. As a result, exposure of the layer 407 to heat will substantially increase the risk of ignition of the mattress 400. To reduce the risk of exposure of the layer 407 to heat, the FR barrier 404 may be positioned between the combustible layer 407 and the ticking 402. Of course, rather than positioning the FR barrier 404 between the layer 407 and the ticking 402, it is fully contemplated that the FR barrier 404 may instead be positioned between first and second layers of a mattress. Regardless of the specific placement of the FR barrier 404 relative to other layers of a mattress, as will be more fully described below, the FR barrier 404 will dissipate at least a portion of heat which, in the absence of the FR barrier 404, would otherwise be transferred from one layer of the mattress to the other, a situation which, as previously set forth, may speed ignition of the mattress considerably.

Referring next to FIG. 5A, the FR barrier 404 will now be described in greater detail. As may now be seen, the FR barrier 404 is comprised of an FR nonwoven fiber batt 502 and a chemical barrier layer 504. The FR barrier 404 (which serves as the FR layer of the mattress shown in FIG. 5A) is positioned between the ticking 402 and the combustible layer 407 of the mattress core 406, more specifically, beneath the ticking 402 and above the combustible layer 407 in FIG. 5A. Of course, the ticking 402 and the combustible layer 407 of the mattress core are purely exemplary and it is fully contemplated that the FR barrier 404 may be used to separate any two layers for which the dissipation of heat normally transferred therebetween is desirable.

The FR nonwoven fiber batt 502 in FIG. 5A is formed from a blend of binder fibers 514 bonded to carrier fibers 516, barrier-type FR fibers 518 as well as other binder fibers 514. Preferably, the barrier-type FR fibers are charring fibers and, even more preferably, the durable non-inherently FR fibers disclosed in co-pending provision U.S. Patent Application Ser. No. 60/813,378 previously referenced herein and incorporated by reference. While black oxidized PAN or other dark charring fibers are functionally suitable for use as the charring fiber, within a product, the FR barrier 404 is typically positioned such that the FR nonwoven batt 502 is positioned in proximity to the open flame or other heat source (toward the exterior of the mattress). So in the example of FIG. 5A, the second side surface 502b of the FR nonwoven fiber batt 502, which is located proximal to the combustible layer 407 in this example, is disposed in proximity to the combustible layer 407 (and in this specific example, is shown disposed against the combustible layer 407), while the first side surface 502a of the FR nonwoven fiber batt 502 is located distal to the combustible layer 407. The chemical barrier layer 504 is disposed in proximity to the first side surface 502a of the FR nonwoven fiber batt 502 (and in this specific example is disposed against the first (distal) side surface of the FR nonwoven fiber batt), such that the chemical barrier layer 504 is disposed distal to the combustible layer 407, with the FR nonwoven fiber batt 502 located between the chemical barrier layer 504 and the combustible layer 407 of the product (such that flame would typically come in contact with the externally located chemical barrier layer 504 first). Accordingly, it is also preferred that the charring or other barrier-type FR fibers are either white or a relative light shade

So the FR nonwoven fiber batt 502 includes FR fibers (specifically charring fibers in this example), such that it may serve as a physical barrier that prevents a heat source from directly contacting the combustible layer 407 of the mattress. The chemical barrier layer 504 of this example is comprised of oxygen depleting chemicals. Thus, when heat from a heat source (such as an open flame) contacts the chemical barrier layer 504, oxygen depleting chemicals will be released in an effort to deprive the flame of the oxygen necessary to sustain combustion. In the embodiment shown in FIG. 5A, phosphorus-based oxygen depleting chemicals are used. Multipolyphosphate is a non-exclusive example of the type of oxygen depleting chemicals that the chemical barrier layer might include. So in the example of FIG. 5A, the chemical barrier layer 504 would emit a gas of oxygen depleting chemicals when heated by the heat source, and these chemicals would displace oxygen from the area. By displacing oxygen from the flame, the intensity/heat of the flame may be reduced.

Generally, a combustible layer 407 of a product may be protected from flame (or other heat sources that might cause combustion) by placing the FR barrier 404 in proximity to the combustible layer 407, with the chemical barrier layer 504 disposed distal to the combustible layer 407. That way, flame would first encounter the chemical barrier layer 504 (typically comprising oxygen depleting chemicals), reducing the intensity of the flame, with the FR nonwoven fiber batt 502 then shielding the combustible layer 407 from direct contact with any remaining heat/flame. As may be further seen in the example of FIG. 5A, the FR nonwoven fiber batt 502 has a first (or distal/upper) side surface 502a and a second (or proximal/lower) side surface 502b. The distal side surface of the FR nonwoven fiber batt 502 is the side surface distal or farthest from the combustible layer 407 being protected, while the proximal side surface of the FR nonwoven fiber batt 502 is the side surface proximal or nearest to the combustible layer 407. Generally, the proximal side surface 502b of the FR nonwoven fiber batt 502 is disposed in proximity to the combustible layer 407, the chemical barrier layer 504 is disposed in proximity to (and in the example of FIG. 5A, applied directly to) the distal side surface 502a of the FR nonwoven fiber batt 502, and the ticking 402 is disposed in proximity to the chemical barrier layer 504 (generally forming the exterior of the product).

In the embodiment shown in FIG. 5A, the proximal side surface 502b of the FR nonwoven fiber batt 502 is disposed against a first (or exterior/upper) side surface 407b of the combustible layer 407. In the embodiment disclosed herein, the proximal side surface 502b of the FR nonwoven fiber batt 502 is mated with, but not secured to, the upper side surface 407b of the combustible layer 407. In the alternative, however, it is contemplated that the proximal side surface 502b of the FR nonwoven fiber batt 502 is fixedly secured to the upper side surface 407b of the combustible layer 407. In contrast, application of the chemical barrier layer 504 to the distal side surface 502a of the FR nonwoven fiber batt 502 of FIG. 5A fixedly secures the chemical barrier layer 504 to the distal side surface 502a of the FR nonwoven fiber batt 502. Finally, a first (or interior/lower) side surface 402a of the ticking 402 is disposed against the chemical barrier layer 504 (on the opposite, exterior, distal side away from the FR nonwoven fiber batt 502). In the embodiment disclosed herein, the lower side surface 402a of the ticking 402 is mated with, but not secured to, the chemical barrier layer 504/FR nonwoven fiber batt 502. In the alternative, however, it is contemplated that the lower side surface 402a of the ticking 402 may be fixedly secured to the chemical barrier layer 504/nonwoven fiber batt 502.

Referring next to FIG. 5B, an alternate embodiment of the FR barrier 404 (having the FR nonwoven fiber batt comprised of a different FR fiber), hereafter identified as FR barrier 404′ will now be described in greater detail. As may now be seen, the FR barrier 404′ is comprised of an FR nonwoven fiber batt 502′ and a chemical barrier layer 504′. The FR barrier 404′ is positioned between the ticking 402 and the combustible layer 407 of the mattress core 406, more specifically, beneath the ticking 402 and above the combustible layer 407 in FIG. 5B. Of course, the ticking 402 and the combustible layer 407 of the mattress core are purely exemplary and it is fully contemplated that the FR barrier 404′ may be used to separate any two layers for which the dissipation of heat normally transferred therebetween is desirable.

The FR nonwoven fiber batt 502′ of FIG. 5B is formed from a blend of binder fibers 514′ bonded to carrier fibers 516′, Visil(t fibers 518′ and other binder fibers 514′. Rather than the Visil(t fibers 518′, in an alternate embodiment thereof, the barrier layer 502′ may instead include an organic, inorganic or hybrid type of fiber which, like Visil®, is generally characterized as a permanently FR fiber that neither melts nor flows when in contact with heat or flame. The FR fibers may be either inherently FR or non-inherently FR fibers.

As may be further seen in the alternate example of FIG. 5B, the FR nonwoven fiber batt 502′ has a first (or distal/upper) side surface 502a′ and a second (or proximal/lower) side surface 502b′. Within a product, the FR barrier 404′ is typically positioned such that the FR nonwoven batt 502′ is positioned in proximity to the open flame or other heat source. So in the example of FIG. 5B, the second side surface 502b′ of the FR nonwoven fiber batt 502′, which is located proximal to the combustible layer 407 in this example, is disposed in proximity to the combustible layer 407 (and in this specific example, is shown disposed against the combustible layer 407), while the first side surface 502a′ of the FR nonwoven fiber batt 502′ is located distal to the combustible layer 407. The chemical barrier layer 504′ is disposed in proximity to the first side surface 502a′ of the FR nonwoven fiber batt 502′ (and in this specific example is disposed against the first (distal) side surface of the FR nonwoven fiber batt), such that the chemical barrier layer 504′ is disposed distal to the combustible layer 407, with the FR nonwoven batt 502′ located between the chemical barrier layer 504′ and the combustible layer 407 of the product (such that flame would typically come in contact with the externally located chemical barrier layer 504′ first). Accordingly, it is also preferred that the charring or other barrier-type FR fibers are either white or a relative light shade.

So the FR nonwoven fiber batt 502′ includes FR fibers (specifically charring fibers in this example), such that it may serve as a physical barrier that prevents a heat source from directly contacting the combustible layer 407 of the mattress. The chemical barrier layer 504′ of this example is comprised of oxygen depleting chemicals. Thus, when heat from a heat source (such as an open flame) contacts the chemical barrier layer 504′, oxygen depleting chemicals will be released in an effort to deprive the flame of the oxygen necessary to sustain combustion (since off-gassing of chemicals displaces oxygen from the area of the flame). In the embodiment shown in FIG. 5B, phosphorus-based oxygen depleting chemicals are used. Multipolyphosphate is a non-exclusive example of the type of oxygen depleting chemicals that the chemical barrier layer might include.

Generally, a combustible layer 407 of a product may be protected from flame (or other heat sources that might cause combustion) by placing the FR barrier 404′ in proximity to the combustible layer 407, with the chemical barrier layer 504′ disposed distal to the combustible layer 407. That way, flame would first encounter the chemical barrier layer 504′ (typically comprising oxygen depleting chemicals), reducing the intensity of the flame, with the FR nonwoven fiber batt 502′ then shielding the combustible layer 407 from direct contact with any remaining heat/flame. As may be further seen in FIG. 5B, the FR nonwoven fiber batt 502′ has a first (or distal/upper) side surface 502a′ and a second (or proximal/lower) side surface 502b′. The distal side surface of the FR nonwoven fiber batt 502′ is the side surface distal or farthest from the combustible layer 407 being protected, while the proximal side surface of the FR nonwoven fiber batt 502′ is the side surface proximal or nearest to the combustible layer 407. Generally, the proximal side surface 502b′ of the FR nonwoven fiber batt 502′ is disposed in proximity to the combustible layer 407, the chemical barrier layer 504′ is disposed in proximity to (and in the example of FIG. 5B, applied directly to) the distal side surface 502a′ of the FR nonwoven fiber batt 502′, and the ticking 402 is disposed in proximity to the chemical barrier layer 504′ (generally forming the exterior of the product).

In the embodiment shown in FIG. 5B, the proximal side surface 502b′ of the FR nonwoven fiber batt 502′ is disposed against a first (or exterior/upper) side surface 407b of the combustible layer 407. In the embodiment disclosed herein, the proximal side surface 502b′ of the FR nonwoven fiber batt 502′ is mated with, but not secured to, the upper side surface 407b of the combustible layer 407. In the alternative, however, it is contemplated that the proximal side surface 502b′ of the FR nonwoven fiber batt 502′ is fixedly secured to the upper side surface 407b of the combustible layer 407. In contrast, application of the chemical barrier layer 504′ to the distal side surface 502a′ of the FR nonwoven fiber batt 502′ fixedly secures the chemical barrier layer 504′ to the distal side surface 502a′ of the FR nonwoven fiber batt 502′. Finally, a first (or interior/lower) side surface 402a of the ticking 402 is disposed against the chemical barrier layer 504′ (on the opposite, exterior, distal side away from the FR nonwoven fiber batt 502′). In the embodiment disclosed herein, the lower side surface 402a of the ticking 402 is mated with, but not secured to, the chemical barrier layer 504′. In the alternative, however, it is contemplated that the lower side surface 402a of the ticking 402 may be fixedly secured to the chemical barrier layer 504′.

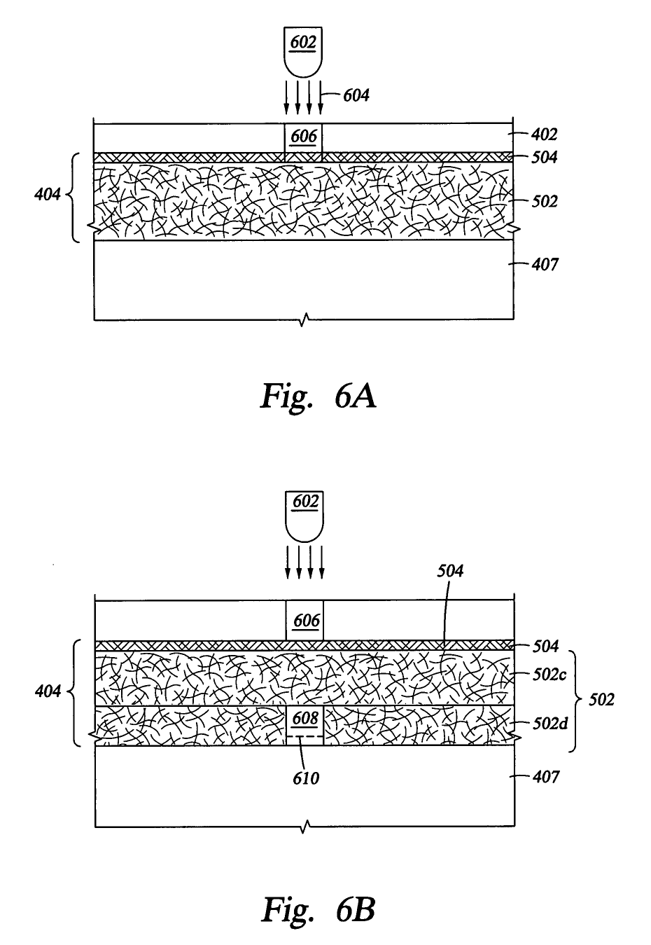

Referring next to FIG. 6A, the response of the FR barrier 404 (shown in FIG. 5A) to a heat source and the resultant effect that the response of the FR barrier 404 will have on the potential for ignition of the mattress 400 will now be described in greater detail. As illustrated herein, the heat source 602 is an open flame in proximity to the mattress 400. It should be readily appreciated, however, that a wide variety of other heat sources, for example, a space heater or other type of heat generating electrical appliance commonly found in a household, may be the source of heat creating the risk of potential ignition of the mattress 400. In FIG. 6A, the heat source 602 is located in distal proximity to the FR barrier 404 (such that the heat source 602 is located beyond the chemical barrier layer 504, with the chemical barrier layer 504 and the FR nonwoven fiber batt 502 of the FR barrier 404 located between the heat source 602 and the combustible layer 407), beyond the ticking 402 that surrounds the mattress 400.

The open flame 602 generates heat 604 which radiates outwardly, from the open flame 602, towards the mattress 400. As representatively illustrated in FIG. 6A, only the heat 604 generated in a direction generally orthogonal to the mattress 400 is shown. It should be clearly understood, however, that an open flame more commonly tends to radiate heat omnidirectionally rather than the unidirectional pattern shown in FIG. 6A. As is common in the bedding industry, the ticking 402 of FIG. 6A is formed using polyester or another heat reactive fiber that tends to retreat rapidly in the presence of the heat 604 radiating from the open flame 602, thereby forming an aperture 606 in the ticking 402 which exposes the FR barrier 404. As illustrated herein, the aperture 606 appears to have been formed in a generally tubular shape. Such a result would typically occur if the heat 604 radiated from the open flame 602 in the pattern illustrated in FIG. 6A. Omnidirectionally radiating heat, on the other hand would result in the aperture 606 have a much more uneven shape, including some portions that have fully penetrated the ticking 402, other portions that have merely partially penetrated the ticking 402 and a relatively jagged periphery resulting from a non-uniform retreat of the ticking 402 from the heat 604 generated by the open flame 602.

Upon fully penetrating the ticking 402, the heat 604 continues radiating towards the FR barrier 404. Oftentimes, the heat 604 is accompanied by a corresponding travel of the open flame 602 generating the heat 604 (such that the open flame might contact the chemical barrier layer 504 located on the distal side surface 502a of the FR nonwoven fiber batt 502). As the flame 602 contacts the FR barrier 404, oxygen depleting chemicals are released, displacing oxygen and reducing the intensity of the flame. Meanwhile, the FR nonwoven fiber batt 502 shields the combustible layer 407 from direct contact with the flame 602, even as the oxygen depleting chemicals of the chemical barrier layer 504 reduce the heat intensity of the flame 602.

So after contacting the chemical barrier layer 504, the open flame 602 contacts the FR nonwoven fiber batt 502. Unlike the ticking 402, the FR nonwoven fiber batt 502 of the FR barrier 404 does not physically retreat in the presence of the heat 604 generated by the open flame 602. Instead, the FR barrier 404 will maintain its structural integrity. For example, if the FR nonwoven fiber batt 502 of the FR barrier 404 is formed using a charring fiber such as a durable FR rayon, the fibers will form a stable char structure when exposed to the open flame 602. Conversely, if formed using a permanently FR fiber such as Visil®, the permanently FR fibers will neither melt nor flow when placed in contact with the open flame 602. In either case, the charring or Visil® fibers will enable the FR barrier 404 to maintain its structural integrity, thereby preventing further penetration of the open flame 602 into the interior of the mattress 400 by shielding the combustible layer 407 from experiencing direct contact with the open flame 602. As a result, the FR barrier 404 may successfully prevent further degradation of the structural integrity of the mattress 400 for a measurable period of time. And due to the effects of the chemical barrier layer 504 (reducing the intensity of the flame before it contacts the FR nonwoven fiber batt), the FR nonwoven fiber batt 502 may withstand the flame longer (in addition to reducing the amount of heat that passes through the FR barrier 404 to the underlying layers).

While the FR barrier 404 will prevent further penetration of the open flame 602, the FR barrier 404 may permit a portion of the heat 604 generated by the open flame to radiate through the FR barrier 404. Given the reduction in the intensity of the flame due to the oxygen depleting chemicals and the FR shielding of the FR nonwoven fiber batt 502, however, the combustible layer 407 will experience significantly less heat, thereby delaying its combustion. Additionally, the char structure formed by the exposure of the FR nonwoven fiber batt 502 to the open flame 602 may release gas and steam energy, thereby resulting in additional general cooling of the mattress 400.

In this manner, the FR barrier 404 of FIG. 6A provides two discrete responses, each of which tends to suppress the combustion of a product having the FR barrier 404 incorporated therein. More specifically, exposure of the chemical barrier layer 504 of the FR barrier 404 to an open flame will result in a discharge of oxygen depleting chemicals (caused by heating), displacing oxygen from the flame in order to rob the flame of the oxygen that could fuel growth and/or sustained burning. In this way, the chemical barrier layer 504 reduces the intensity of the flame 602, so that the combustible layer 407 will experience less heat. Additionally, exposure of the FR barrier 404 to an open flame 602 will result in the formation of a char structure that tends to cool the product and to shield the combustible layer of the product from direct contact with the heat source. These two responses of the FR barrier 404 work together to provide the mattress 400 with enhanced FR capabilities.

Optionally, as shown in FIG. 5C, the FR nonwoven fiber batt 502 may be a bi-layer batt comprised of a barrier layer 502c (which shields combustible layers from contact with flame, as described above) and a heat reactive layer 502d (which retreats in response to heat, forming an aperture 608 of air that may insulate the combustible layer 407 by serving as a heat sink to trap heat from passing through to the combustible layer 407). The barrier layer 502c would typically be located distally, while the heat reactive layer 502d would be located (proximally) in proximity to the combustible layer 407 of a product. Thus, the barrier layer 502c may serve to shield the heat reactive layer 502d from direct contact with a heat source (by serving as the exterior portion of the FR nonwoven fiber batt 502), while the heat reactive layer 502d is operable to retreat as a portion of the heat from a heat source radiates through the barrier layer 502c, thereby forming an aperture 608 (that serves to further insulate the combustible layer 407 from the heat source 602, as shown in FIG. 6B). While not required, use of such an optional bi-layer batt (having a heat reactive layer shielded by a barrier layer) may serve to enhance the FR characteristics of FR nonwoven fiber batt 502 of the FR barrier 404. Such a bi-layered FR nonwoven fiber batt is described in more detail in co-pending application Ser. No. ______ (4003-21502 duplex) entitled “heat absorptive bi-layer fire resistant nonwoven fiber batt”, which is incorporated by reference herein as if fully recited. Regardless of the number and/or type of layers within the FR nonwoven fiber batt 502, the chemical barrier layer 504 would typically be applied to the distal/exterior surface of the batt so that the oxygen depleting chemicals may reduce the heat experienced by the shielding batt.

FIG. 5C illustrates an exemplary embodiment of an FR barrier 404 having a chemical barrier layer 504 and an FR nonwoven fiber batt 502, with the FR nonwoven fiber batt further comprised of a barrier layer 502c and a heat reactive layer 502d. The heat reactive layer 502d is located proximal to the combustible layer 407 (and in the example of FIG. 5C, is disposed against the combustible layer 407). The barrier layer 502c is located in distal proximity to the heat reactive layer (and in the example of FIG. 5C, is disposed against the exterior (distal) surface of the heat reactive layer). The chemical barrier layer 504 is located in distal proximity to the barrier layer 502c (and in the example of FIG. 5C, is disposed against the exterior (distal) surface of the barrier layer). The ticking 402 is located in distal proximity to the chemical barrier layer 504, forming the exterior of the product (and in the example of FIG. 5C, is disposed against the exterior (distal) surface of the chemical barrier layer).

FIG. 6B illustrates the response of the FR barrier of FIG. 5C to the application of flame/heat source, showing how the barrier layer 502c of the FR nonwoven fiber batt 502 shields both the heat reactive layer 502d and the combustible layer 407 of the product from direct exposure to the flame (after the chemical barrier layer 504 of the FR barrier 404 acts upon the flame to reduce its intensity), while the heat reactive layer 502d physically retreats from the remaining heat that passes through the barrier layer 502c to form an aperture 608 extending from the distal surface (bordered by the barrier layer 502c) to either an interior surface 610 of the heat reactive layer 502d, or in a worst case scenario, to the proximal surface (bordered by the combustible layer 407). The aperture 608 may serve to insulate the combustible layer 407 from the heat. And when the barrier layer 502c includes charring fibers, it would also tend to release gas and steam energy when exposed to an open flame, thereby resulting in general cooling of the mattress 400. In this way, the FR barrier 404 of FIG. 6B may act to reduce the intensity of the flame, cool the mattress, shield the combustible layer 407 from direct contact with flame, and provide an insulating pocket (aperture 608) to reduce heat transfer through to the combustible layer 407 of the mattress, all in an attempt to prevent and/or delay combustion of the mattress (providing additional time for escape during a fire, for example).

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Accordingly, the scope of protection is not limited by the description set out above, but is defined by the claims which follow, that scope including all equivalents of the subject matter of the claims. Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings refer to a “Field of the Invention,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. The term “comprising” as used herein is to be construed broadly to mean including but not limited to, and in accordance with its typical usage in the patent context, is indicative of inclusion rather than limitation (such that other elements may also be present). In all instances, the scope of the claims shall be considered on their own merits in light of this disclosure, but should not be constrained by the headings set forth herein.

What is claimed is:

1. A fire resistant (“FR”) barrier, comprising:
a nonwoven fiber batt having a first side surface and a second side surface, said nonwoven fiber batt formed from a homogeneous fiber blend comprising FR fibers and carrier fibers; and
a chemical barrier having FR characteristics, wherein said chemical barrier is applied to said first side surface of said nonwoven fiber batt.

2. An FR barrier as in claim 1, wherein said homogeneous fiber blend further comprises binder fibers.

3. An FR barrier as in claim 2, wherein said carrier fibers comprise polyester carrier fibers and said binder fibers comprise polyester binder fibers.

4. An FR barrier as in claim 1, wherein said nonwoven fiber batt further comprises resin operable to adhere said fibers of said homogenous fiber blend.

5. An FR barrier as in claim 1, wherein said chemical barrier comprises oxygen depleting chemicals.

6. An FR barrier as in claim 1, wherein said chemical barrier comprises phosphorus-based FR chemicals.

7. An FR barrier as in claim 1, wherein said chemical barrier comprises multipolyphosphate.

8. An FR barrier as in claim 1, wherein said FR fibers are operable to neither melt nor flow when in contact with heat or flame.

9. An FR barrier as in claim 1, wherein said FR fibers comprise inherently FR fibers.

10. An FR barrier as in claim 9, wherein said inherently FR fibers comprise durable FR rayon or Visil® fibers.

11. An FR barrier as in claim 1, wherein said FR fibers comprise non-inherently FR fibers treated with a fire retardant chemical.

12. An FR barrier as in claim 11, wherein said non-inherently FR fibers comprise cellulosic fibers selected from the group consisting of rayon, cotton, jute, shoddy, wool, and silk.

13. A product incorporating the FR barrier of claim 1, said product having a combustible layer, wherein said second side surface of said nonwoven fiber batt is disposed in proximity to the combustible layer.

14. A product as in claim 13, wherein said product is selected from the group consisting of mattresses, bed clothing, upholstered cushions, and automotive firewalls.

15. A method for forming a fire resistant (“FR”) barrier, comprising:
forming a homogeneous blend of fibers comprising FR fibers and carrier fibers;
forming a nonwoven fiber batt from said homogeneous blend of fibers, wherein said nonwoven fiber batt has a first side surface and a second side surface; and
applying a chemical barrier having FR characteristics to said first side surface of said nonwoven fiber batt.

16. A method as in claim 15, wherein applying the chemical barrier comprises spraying oxygen depleting chemicals onto the first side surface.

17. A method as in claim 15, wherein applying the chemical barrier comprises foaming oxygen depleting chemicals onto the first side surface.

18. A method as in claim 15, wherein said homogeneous blend of fibers further comprises binder fibers, and forming the nonwoven fiber batt comprises thermally bonding the binder fibers to the FR fibers, the carrier fibers, and to each other.

19. A method as in claim 15, further comprising treating non-inherently FR fibers with a fire retardant chemical to form the FR fibers.

20. A method as in claim 15, wherein said FR barrier is used with a product having a combustible layer, said method further comprising disposing said second side surface of said nonwoven fiber batt in proximity to the combustible layer of the product.
